(19) United States
(12) Patent Application Publication
(10) Pub. No.: US 2008/0014380 A1
(43) Pub. Date: Jan. 17, 2008

(54) IRIDESCENT FILM WITH BARRIER PROPERTIES

(76) Inventors: Steven Jones, Budd Lake, NJ (US); Greg Coughlin, Nanuet, NY (US)

Correspondence Address: BASF CATALYSTS LLC, 100 CAMPUS DRIVE, FLORHAM PARK, NJ, 07932, US

(21) Appl. No.: 11/747,383

(22) Filed: May 11, 2007

Related U.S. Application Data
(60) Provisional application No. 60/747,156, filed on May 12, 2006.

(51) Int. Cl. B44F 1/14; B05D 1/36

(52) U.S. Cl. 428/30; 427/372.2; 427/402

(57) ABSTRACT

The present patent application is directed to an iridescent film having an outer coating. This product has good barrier properties and thus, may be used in packaging of cosmetic and personal care products in a flexible or rigid decorative container and in gas containing articles such as balloons

The present application claims priority from U.S. Provisional Patent Application No. 60/747,156, which was filed on May 12, 2006, the disclosure of which is incorporated herein by reference in its entirety.

### BACKGROUND

Packaging materials serve many purposes. Besides the basic containment of the contents for easy storage and transport, packaging materials can also protect the contents from physical damage as well as from damages caused by vapor transport through the packaging material. Examples of such vapor transport include the diffusion of oxygen and water into the packaging and the diffusion of flavors, fragrances, and modified atmosphere gases out of the packaging. Packaging materials that prevent or sufficiently diminish such vapor diffusion are said to possess barrier properties. Glass and ceramic packaging have excellent barrier properties. Plastic materials are more often desired for packaging for various reasons, but one major drawback is their low barrier properties. Certain polymers such as EVOH and PVDC may be incorporated into packaging to improve barrier properties.

Another important aspect of packaging is its appearance, especially when used for packaging of consumer goods. The package's shape and color are used to draw the attention of consumers as well as to provide brand identity. Beyond a straight color such as red or blue, packaging may also incorporate special effects such as pearlescence obtained from mica based pigments, or a multi color iridescence provided by iridescent films. Since iridescent films are polymer based, they do not typically have good barrier properties. It is desired to have an iridescent film with barrier properties so that it can be used in packaging applications where barrier is needed.

On www.inmat.com, Nanolok™ coatings are advertised for providing an oxygen barrier. The coatings are aqueous suspensions of nanodispersed silicates in a polymer matrix for application to polyester film or other substrates using appropriate adhesives.

Since the Nanolok™ coatings are not advertised for multilayered or iridescent films, we did not know whether such nanodispersed silicates suitable for providing an oxygen barrier on a polyester film would work on a multilayered iridescent film to provide a barrier film.

Balloons are typically filled with helium and thus, any material used to make a balloon must have helium barrier properties. Oxygen is a larger size molecule than helium. Thus, an oxygen barrier may or may not be a helium barrier.

### SUMMARY

The present patent application is directed to an iridescent film having an outer coating. This product has barrier properties and thus, may be used in balloons and other gas containing articles.

### DETAILED DESCRIPTION

Iridescent Film:

The present iridescent film is made of a plurality of alternating layers of polymeric materials. The first and second polymers of the present invention may have indices of refraction that differ by at least about 0.03 and preferably 0.06. This difference in refractive index between the adjacent layers results in an iridescent film when the film is exposed to light. These films may contain at least about 10 layers, preferably at least about 35 layers, and more preferably at least about 70 layers. The individual layers of the film are very thin, usually in the range of generally about 15 nanometers (nm) to about 500 nm and preferably about 50 nm to about 400 nm. Generally, the thickness of the inner layers ranges from about 15 nm to about 200 nm and the thickness of the outer layers ranges from about 1 to about 2 microns.

Preferred polymers for the film layers include polyesters, polyacrylates, polyethylene vinyl acetate, polyolefins, and polystryenes. Preferred polyesters include polyethylene terephthalate, polybutylene terephthalate, glycol modified polyethylene terephthalate, and polyethylene naphthalate as disclosed in commonly assigned U.S. Pat. No. 6,475,608, incorporated herein by reference. A preferred polyacrylate includes polymethyl methacrylate. One preferred film has alternating layers of polybutylene terephthalate (hereinafter “PBT”) and polymethyl methacrylate (hereinafter “PMMA”). Another preferred film has alternating layers of polyethylene terephthalate (hereinafter “PET”) and polymethyl methacrylate. Another preferred film has alternating layers of polystyrene and ethylene vinyl acetate (hereinafter “EVA”). Another preferred film has alternating layer of polyethylene naphthalate and polymethyl methacrylate. Another preferred film has alternating layers of polyethylene terephthalate and ethylene methyl acrylate (hereinafter 5 “EMA”). Another preferred film has alternating layer of polyethylene naphthalate and polymethyl methacrylate. The layers may be colored or tinted as taught by commonly assigned U.S. Pat. No. 5,451,449.

Commonly assigned U.S. Pat. No. 4,310,584 teaches an iridescent film comprising an optical core of alternating polymeric layers and layers on the outside of the core known as the skin layers.

The multilayer films are usually made by a chill-roll casting technique in which melts of the thermoplastic resinous material from two or more extruders are collected by a feedblock which arranges them into a desired layered pattern. The very narrow multilayer stream flows through a single manifold flat film die with the layers simultaneously spread to the width of the die and thinned to the final die exit thickness. The number of layers and their thickness distribution can be changed by using a different feedblock module. Usually, the outermost layer or layers on each side of the sheet is thicker than the internal layers so as to form a relatively thick skin in a substantially equal division. Preferably, the present film is made by a process diclosed in U.S. Pat. No. 3,801,429, incorporated herein by reference to the extent necessary to complete this disclosure. Commonly assigned U.S. Pat. No. 5,451,449, incorporated herein by reference to the extent necessary to complete this disclosure, discloses that polyethylene terephthalate thermoplastic polyester was fed to the feedblock from one extruder, polymethyl methacrylate was fed to the feedblock from another extruder, and polybutylene terephthalate was added as a skin layer to each outer surface from a third extruder.

Coating Composition:

The coating is an aqueous suspension of nanodispersed silicates in a polymer matrix. The coating is intercalated and exfoliated as defined below.

The term “aspect ratio” is characteristic of every platelet material in solid form. Aspect ratio is the product of the lateral dimension of a platelet, e.g. mica flake, divided by the thickness of the platelet.

Intercalation is defined as the state of a coating composition in which polymer is present between each layer of a silicate platelet. 5 Intercalation may be defined by the detection of an X-ray line, indicating a larger spacing between platelet layers than in the original mineral. Exfoliation describes the complete separation of the individual platelet layers so that polymer completely surrounds each particle. Desirably, enough polymer is present between each platelet so that the platelets are randomly spaced. No X-ray line appears because the exfoliated platelets are randomly spaced.

One useful silicate is a vermiculite known as MICROLITE® 963++ waterbased vermiculite dispersion (W. R. Grace, see, EP Application No. 601,877 published Jun. 15, 1994)] which is a 7.5% by weight aqueous solution of dispersed mica. This vermiculite has a very high aspect ratio. The vermiculite plates have an average lateral size of between 10 and 30 microns. The plates are largely exfoliated in water, and thus their thickness is 1-2 nm. The aspect ratio of the filler is water dispersions average of 10,000-30,000. It is clear that many plates reassemble during the coating and drying process of the 20 present invention, thus reducing the effective aspect ratio achieve in the final coasting. However, it is great advantage to start with as large an aspect ratio as possible.

Other useful less exfoliated grades of MICROLITE vermiculite are grades 963, 923, and 903. Other layered silicates are also useful in the coatings of this invention. The effectiveness of other silicates in the barrier coating of this invention depends upon the lateral size of the platelets, the degree of exfoliation in water, and the degree to which they reassemble to form larger particles during the coating and drying process. Examples of other layered silicates include bentonite, vermiculite, montmorillonite, nontronite, beidellite, volkonskoite, hectorite, saponite, laponite, sauconite, magadiite, kenyaite, ledkite, and mixtures of the above silicates.

Film Preparation:

The coating may be applied via gravure coating to the iridescent film. The coating is then dried to form a very thin application with a thickness between about 0.25 to 2 microns on the iridescent film.

To form the coated film of this invention, the application of the selected coating mixture may be accomplished by techniques 5 including, without limitation, roller transfer or paint coating, spray coating, brush coating and dip coating. Roll coating techniques include, but are not limited to, rod, reverse roll, forward roll, air knife, knife over roll, blade, gravure and slot die coating methods. General descriptions are these types of coating methods may be found in texts, such as Modern Coating and Drying Techniques, (E. Cohen and E. Gutoff, eds; VCH publishers) New York (1992) and Web Processing and Converting Technology and Equipment, (D. Satas, ed; Van Nostrand Reinhold) New York (1984).

After coating, the coated film, may be dried at a selected temperature, e.g. room temperature or greater than room temperature. The selection of the drying temperature, relative humidity, and convective air flow rates depends on the desired time for drying; that is, reduced drying times may be achieved at elevated air temperatures lower relative humidity, and higher rates of air circulation over the drying coating surface. After drying, the exfoliated silicate filler particles are orientated within the polymer to a high degree parallel to each other and to the iridescent film. One of skill in the art can readily adjust the drying conditions as desired. The performance of the dried barrier coating is insensitive to drying temperatures over the range 25-160° C.

The evaluation of permeability of the present coated iridescent film is determined using the following parameters. The oxygen transmission rate (OTR) of the dried coating on the articles, or the free standing film, is generally measured using conventional apparatus, such as a MOCON® OX-TRAN 2/20 module. OTR units are cc/m2 day at 1 atmosphere, 0% relative humidity at 23° C. The permeability of the coating is calculated by multiplying the OTR and coating thickness. Permeability units are cc mm/m2 day atmosphere at 0% humidity at 23° C. The permeability of the known substrate is subtracted out using the following equation:

Permeability of the barrier coating=X1/[1/OTR)−(X2/Px2)], where X1 is coating thickness; X2 is iridescent film thickness and Px2 is permeability of the iridescent film. The reduction in permeability from the uncoated iridescent film is calculated by dividing the permeability of the uncoated iridescent film by the permeability of the coated iridescent film. Reduction 5 in permeability is unitless.

Utility:

The present coated iridescent film may be used in gas containing articles such as balloons.

The present invention may be used in flexible and rigid decorative packaging. Rigid decorative packaging includes but is not limited to cosmetic and personal care containers such as for skin care products such as facial mask, UV protective lotion, liquid soap, and antimicrobial product; hair care products such as shampoo, conditioner, hair spray or fixative, and hair colorant; makeup products such as nail polish, mascara, eye shadow, and perfume; shaving cream, deodorant, baby oil, and dental products. The present film may also be used in printed and laminated board for use in packaging. The present film may also be used in vertical form and fill packaging which is a type of packaging equipment which feed the packaging film into a shaped area where it can be heat sealed in any of several ways and the package is then filled with something and sealed shut. The dimensions of the finished package are determined by the width of the film fed into the machine and the length of the bag is controlled by the speed and frequency settings at the sealing head. Numerous items may be packaged into a finished iridescent film pouch or bag in this way.

The present film may also be used as a label for various containers. Such containers include but are not limited to cosmetic and personal care containers such as for skin care products such as facial mask, UV protective lotion, liquid soap, and antimicrobial product; hair care products such as shampoo, conditioner, hair spray or fixative, and hair colorant; makeup products such as nail polish, mascara, eye shadow, and perfume; shaving cream, deodorant, and baby oil. The present invention may also be used on a colored substrate including a transparent container filled with colored liquid.

What is claimed is:

1. An iridescent film having a silicate coating.

2. The iridescent film of claim 1 wherein the silicate coating is formed by applying an aqueous suspension of nanodispersed silicates in a polymer matrix on the surface of an iridescent film.

3. The silicate coating of claim 2 wherein the nanodispersed silicates are selected from the group consisting of vermiculite, bentonite, montmorillonite, nontronite, beidellite, volkonskoite, hectorite, saponite, laponite, sauconite, magadiite, kenyaite, ledkite and mixtures thereof.

4. The silicate coating of claim 2 wherein the nanodispersed silicates comprise vermiculite.

5. The iridescent film of claim 1 wherein the silicate coating has a thickness between about 0.25 to about 2 microns.

6. A process for making an iridescent film having a silicate coating comprising:
a. applying an aqueous suspension of nanodispersed silicates in a polymer matrix on the surface of an iridescent film to form a coated film; and
b. drying the coated film at a selected temperature.

7. The process of claim 6 wherein the selected temperature is between 25 deg C. and 160 deg C.

8. An article comprising an iridescent film having a silicate coating and means for filling said article with gas.

9. The article of claim 8 wherein the gas is selected from the group consisting of air, helium, hydrogen, oxygen, nitrogen, carbon dioxide, argon, neon, krypton, xenon and mixtures thereof.

10. The article of claim 8 wherein the gas is helium.

11. A method comprising laminating an iridescent film having a silicate coating on a printed or laminated board.

12. A method comprising containing cosmetic and personal care products in a flexible or rigid decorative container laminated with an iridescent film having a silicate coating.

13. The method of claim 12 wherein the cosmetic and personal care products are selected from the group consisting of facial mask, UV protective lotion, liquid soap, antimicrobial products, shampoo, conditioner, hair spray, hair fixative, hair colorant, nail polish, mascara, eye shadow, perfume, shaving cream, deodorant, baby oil, and dental products.

14. The method of claim 12 wherein the container is a bag.

15. The method of claim 12 wherein the container is a tube.

16. A method comprising filling gas, liquid or solid in a container laminated with an iridescent film having a silicate coating and means for sealing the container.
